(19) United States
(12) Patent Application Publication
(10) Pub. No.: US 2024/0214756 A1
(43) Pub. Date: Jun. 27, 2024

(54) AUDIO SIGNAL PROCESSING AND SUPER-RESOLUTION ANALYSIS

(71) Applicant: GRAPHAUDIO, INC., Beverly Hills, CA (US)

(72) Inventors: Nermin OSMANOVIC, Austin, TX (US); Lorance WILSON, San Jose, CA (US); Burt FOWLER, Buda, TX (US)

(21) Appl. No.: 18/556,831

(22) PCT Filed: Apr. 20, 2022
(86) PCT No.: PCT/US2022/025498

§ 371 Date: Oct. 23, 2023

Related U.S. Application Data
(60) Provisional application No. 63/178,995, filed on Apr. 23, 2021.

(51) Int. Cl. H04R 29/00; H04R 19/02

(52) U.S. Cl. CPC H04R 29/001; H04R 19/02

(57) ABSTRACT

The present application relates systems, devices, and methods for providing objective quality classifications and/or assessments of analog electrical audio signals. Such classifications and assessments are helpful for objectively evaluating the performance of certain audio hardware, for example, audio converters, amplifiers, etc. Embodiments of the present application provide exemplary devices, hardware, and methods.

### FIELD OF THE INVENTION

The present application relates systems, devices, and methods for providing objective quality classifications and/or assessments of analog electrical audio signals. Such classifications and assessments are helpful for objectively evaluating the performance of certain audio hardware, for example, audio converters, amplifiers, etc. Embodiments of the present application provide exemplary devices, hardware, and methods.

### BACKGROUND

Recent developments in audio transducers have led to devices capable of producing superior sound as compared to traditional technologies. For example, graphene, when grown correctly, inherently generates an extremely high-quality response. Recent advancements in graphene transducers (e.g., as detailed in PCT/US2013/075821, PCT/US2016/019373, PCT/US2019/045486, PCT/US2019/049860, and PCT/US2020/061957) demonstrate the capabilities of such devices.

Human hearing is capable of discerning even small differences in frequency shape of sound events, as humans can perceive sound in extremely high resolution in both the time and frequency domains. Meanwhile, infrasonic, sonic, and ultrasonic technologies (sensing, communications, etc.) are becoming sufficiently complex to functionally rely on small variations in the time and frequency domains to carry and receive information. While recently developed transducers are capable of producing nuanced sound having a high resolution in both time and frequency domains, in doing they must necessarily rely on the electrical systems driving the transducers. In particular, the signal driving the transducer must be of sufficient quality such that small variations in time and frequency domains can be accurately and repeatably reproduced. An inferior signal will only generate inferior sound, even when using a superior transducer.

Accordingly, there is a need to ensure the electrical signals driving the transducers are also of the highest quality possible, as well as a need to ensure the associated circuitry, including amplifiers, ADCs, and DACs, are also of the highest quality possible. There is also a need to ensure the transducer used is of sufficient quality to generate a high-quality response. Current approaches are insufficient because they cannot evaluate a signal with sufficient resolution in both the time and frequency domains.

### SUMMARY

The inventors of the present application have invented novel systems, devices, and methods for objectively evaluating analog electrical signals with super-resolution, down to 1 microsecond (μs) resolution in the time domain and 1 Hz resolution in the frequency domain. The inventors of the present application have also invented novel ways of providing objective quality classifications and/or assessments of analog electrical audio signals and associated hardware. The inventors of the present application have also invented novel ways of evaluating transducer response.

In one aspect, the present application provides an evaluation system to calculate nanotransducer acoustic class using ultra-high-fidelity signal capture and super-resolution signal analysis. Because it is only 100-300 nm thick, the graphene transducer inherently generates extremely high-quality signals. To measure this ultra-high-fidelity, it is necessary to provide super-resolution data capture and analysis. In general, the audio performance of any audio device can be measured by analyzing the output signal of the transducer and at the input of the amplifier. Audio signal performance can be measured using several approaches:
1) Amplifier—Measuring quality of electric output signal by directly connecting to amplifier terminals;
2) Membrane—Measuring directly the excursion of the membrane using laser interferometry;
3) Enclosure—Measuring mechanical vibrations using an accelerometer;
4) Device Under Test (DUT)—Measuring acoustic signal quality using a high-quality microphone.

Measuring the electrical signal performance is typically performed without any transducers connected to the amplifier output terminals to measure the ‘pure’ baseline quality. A dummy load (capacitive, inductive, and/or resistive) can be added for additional ‘loaded’ measurements. This ensures high-quality measurement of amplifier definition, which is necessary to capture the ‘pure’ audio signal performance.

Once the audio amplifier has been confirmed to provide high-fidelity playback, then measurements of transducer output quality may commence. Each transducer inherently has a transfer function that affects the acoustic output presented to the listener. Therefore, it is very important to understand how the transducer impacts the quality of the audio signal. In addition, most devices that produce acoustic signals include an acoustic enclosure that also affects audio signal quality because each acoustic enclosure introduces a unique transfer function. Therefore, it is important to understand the properties of each component of the system.

The high-quality audio performance of the amplifier is evaluated using the following metrics: wideband noise floor, the frequency response of the max power and the medium power, THD response of the max power and medium power, cross-talk, intermodulation distortion, phase response, and transient response. By using these metrics, audio amplifier performance can be fully measured.

An example of the full system used for reference evaluations includes an input Digital-to-Analog Converter (DAC), amplifier, transducer, acoustic enclosure, and human listener or test microphone. The test input microphone may be used to capture the output from the transducer, e.g. a graphene transducer, for additional analyses. The test source signal is presented at the input of the amplifier and captured by the microphone when the acoustic wavefront is created by the transducer and propagated through the acoustic enclosure. Once the acoustic signal is captured using the test microphone, it is processed using an algorithm and reported back to the user.

In one aspect, a method, device, or system according to the present application determines a number of acoustic parameters and combines them into a single score representing the overall audio signal quality, or CLASS, e.g.:
“A CLASS” is the perfect ideal playback quality;
“B CLASS” is the transducer playback quality level;
“C CLASS” is the dynamic transducer playback CLASS;
“D CLASS” is the speech/handset quality CLASS;
“F CLASS” is a very poor-quality signal.

The method, device, or system may then suggest certain improvement steps for all results lower than a predefined class, e.g. lower than “B CLASS”. In some embodiments, this may be called a “SIGNAL OPTIMIZER” function. Improving the acoustic wavefront quality can potentially be done using a System-On-a-Chip (SoC) or Digital Signal Processor (DSP) in a way that maximizes signal class. (Class A, B, C, D, or E).

Within the device, method, or system, an operator may control parameters of the test, including: the type of transducer; type of amplifier; type of headphone, and type of headphone shape. Therefore, the device, method, or system can be extended for use in multiple scenarios. The acoustic wavefront must be analyzed with super-high resolution in both time and frequency domains to capture intricate details present in transducer playback. A simple comparison for better comprehension would be to compare this approach with ‘slicing’ of the three-dimensional wavefront feature so that all the information about dips and peaks of the contour can be properly captured and analyzed. Therefore, a mix of techniques must be utilized to achieve high-enough resolution (“super-resolution”) across the frequency range: low-frequency domain, while achieving extremely high resolution in the time domain (“transient response”), and being able to analyze this data that represents 3-dimensions of the acoustic wavefront. The acoustic wavefront contains x, y, and z dimensions similar to the natural layout of the land when looking from an airplane. However, the acoustic wavefront contains pressure variations related to refraction and rarefaction (i.e., wave compression and decompression), also known as high/low-pressure variations over time. This means that the air particles are not moving themselves, but the actual wavefront is moving on its own in space, over time. In its most basic form, the signal performance evaluation of the acoustic class can be simplified to measurements of pressure variations of the acoustic wavefront.

Thus, another aspect of the present application provides a golden analog electrical audio signal, or a “golden signal,” that is specifically engineered to enable super-resolution evaluation down to 1 us resolution in the time domain and 1 Hz resolution in the frequency domain. In one embodiment, the test analog audio signal is created by multiplying two electrical audio signals: (1) a sinusoidal frequency sweep, and (2) a custom square wave frequency sweep. In this way, the sinusoidal frequency sweep and the custom square wave frequency sweep are modulated on top of each other to produce the golden analog electrical audio signal. Specific embodiments of the sinusoidal frequency sweep, the custom square wave frequency sweep, and the golden analog electrical audio signal are provided further below in the present application.

In another aspect, a golden analog electrical audio signal according to the present application is stored in the memory of a hardware device that is designed to evaluate the quality of a test signal. The test signal is produced by a test source, and the test signal is meant to be as similar to the golden signal as possible. Thus, for example, if the test source being evaluated is an amplifier, then a copy of the golden signal may be provided to the input of the amplifier, and the output of the amplifier may be fed into the hardware device as the test signal to be evaluated. In other embodiments of the present application, other types of hardware may also be evaluated, including (but not limited to) digital-to-analog converters (DACs) and analog-to-digital converters (ADCs). Thus, the present application provides methods for evaluating analog electrical audio test signals, as well as methods for evaluating certain hardware that produces the test signals.

In one aspect, the hardware device includes a plurality of components. In some embodiments, the hardware device includes a memory to store the golden signal and/or the test signal. In some embodiments, the hardware device includes a line-in for receiving a test signal. In some embodiments, the hardware device includes a line-out for sending the golden signal. In some embodiments, the hardware device includes other interfaces and/or connections for receiving or sending signals or information, including wired and wireless interfaces.

Some embodiments of the hardware device include an SoC (system on a chip). In some embodiments, the SoC includes hardware encoded logic for evaluating the golden signal and test signal. In some embodiments, the SoC includes one or more of a CPU, GPU, coprocessor, microcontroller, wired/wireless communication interface, memory, I/O, secondary storage, power supply, and/or other components. In some embodiments, the SoC may be included in a package on package (POP) configuration. In some embodiments, the hardware device includes a motherboard-based architecture, which separates components based on function and connects them through a central interfacing board (rather than a single integrated circuit). The motherboard-based architecture can include all of the components that would be included in an SoC. In some embodiments, the hardware device can include an SoC and motherboard-based architecture.

In some embodiments, the hardware device includes a high-quality digital signal processor (DSP). In some embodiments, the hardware device includes an oscilloscope. In some embodiments, the hardware device includes a digital audio workstation.

In another aspect, the hardware device performs a time-sync operation and divides the test signal and golden signal into a plurality of sub-bands using a filter bank in a series of temporal resolutions. In one embodiment, three temporal domains are used, which are 0-100 microseconds (ultra-fast analysis), 100 microseconds-10 milliseconds (fast analysis), and 10 milliseconds-200 milliseconds. The audio frames are input “sample-to-sample” up to a specific number of samples needed for each temporal domain. In a typical sliding-window frame analysis fashion, frames are extracted and processed separately in each sub-processing block. In one embodiment, the plurality of sub-bands are each 1 Hz in width and cover the entire frequency range of the test signal, i.e., the bands are 1-2 Hz, 2-3 Hz, 3-4 Hz, . . . 95,999-96,000 Hz for a test signal having a frequency range of 1 Hz to 96,000 Hz (96 KHz). Other temporal domains may be used as described further below. Other sub-bands may also be used as described further below.

In another aspect, the hardware device evaluates the objective quality of the test signal by aggregating the differences between the test signal and the golden signal across all filter bank sub-bands and temporal resolutions. The aggregated differences are used to determine the quality of the test signal. Certain embodiments of the hardware device of the present application can provide a numerical value of the aggregated differences, or can associate the numerical value with another indicator, e.g. a letter grade. For example, in one embodiment, if the sum of the differences between the test signal and the golden signal is less than 0.01%, the signal is graded as an “A”, if the differences are between 0.01% and 0.10%, the signal is graded as a “B”, if the differences are between 0.10% and 0.40%, the signal is graded as a “C”, if the differences are between 0.40% and 0.70%, the signal is graded as a “D”, if the differences are between 0.70% and 1%, the signal is graded as “E”, and if the differences are greater than 1%, the signal is graded as an “F”. It should be understood other threshold values may be used for each letter grade, or other kinds of indicators may be used, including (but not limited to) number grades, descriptive labels (“excellent”, “great”, “good”, etc.), ranking, all of which fall within the intended scope of the present application.

Another aspect of the present application provides a method of testing the hardware device itself. One embodiment provides configuring the hardware device in a feedback loop, where the golden signal is provided from an output on the hardware device to the input on the hardware device designed to receive a test signal. In this way, the golden signal is evaluated against itself using the components in the hardware device. Such testing may be carried out to ensure the hardware device contains components capable of evaluating a test signal with the resolution required by the operator. Such testing may also be carried out to ensure the hardware is functioning correctly before evaluating a test signal.

Further objects, features, and advantages of the present application will become apparent from the detailed description of preferred embodiments which is set forth below when considered together with the figures and drawings.

### BRIEF DESCRIPTION OF FIGURES OF DRAWING

FIG. 1 depicts an exemplary embodiment of a sinusoidal frequency sweep, a custom square wave frequency sweep, and a composite golden analog electrical audio signal (or “golden signal”) according to the present application.

FIG. 2 depicts an overview block diagram of a method or system according to the present application.

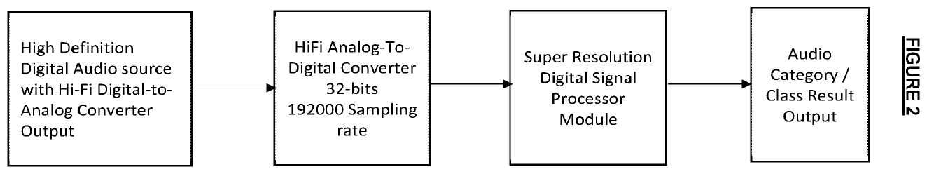

FIG. 3 depicts a detailed block diagram of a method or system according to the present application.

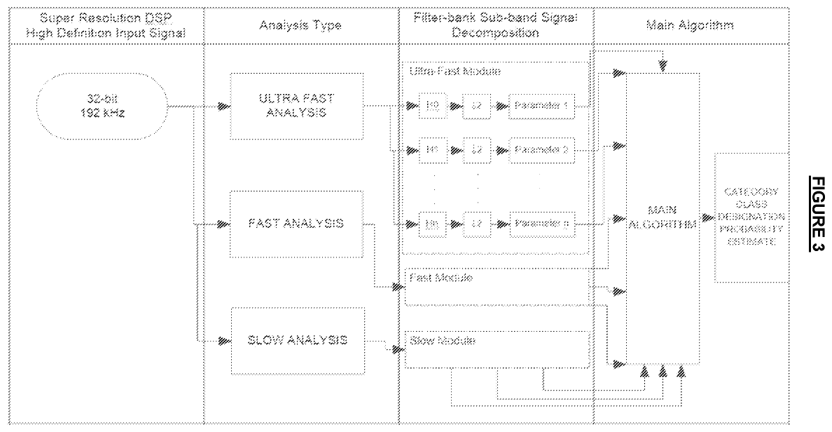

FIG. 4 depicts an exemplary embodiment of a sinusoidal frequency sweep, a custom square wave frequency sweep, and a composite golden analog electrical audio signal (or “golden signal”) according to the present application.

### DETAILED DESCRIPTION OF PREFERRED EMBODIMENTS

The inventors of the present application have invented novel systems, devices, and methods for objectively evaluating analog electrical signals with super-resolution, down to 1 us in the time domain and 1 Hz in the frequency domain. The inventors of the present application have also invented novel ways of providing objective quality classifications and/or assessments of analog electrical audio signals and associated hardware.

In the context of the present application, the terms “about” and “approximately” mean any value that is within +10% of the value referred to. For example, a statement specifying a frequency of “about” or “approximately” 100 Hz would include frequencies of 90 Hz to 110 Hz. The term “substantially” is used to indicate that a value is close to a targeted value, where close means within 90% of the targeted value.

The term “infrasonic” when referring to an acoustic wave means the acoustic wave has a frequency below the human audible range, i.e. below 20 Hz. The term “ultrasonic” when referring to an acoustic wave means the acoustic wave has a frequency above the human audible range, i.e. above 20 KHz. The term “human audible range” or the like when referring to an acoustic wave means the acoustic wave has a frequency within the human audible range, i.e. between 20 Hz and 20 KHz.

An acoustic wave may be referred to as a sound wave in various parts of this application, or vice versa.

The terms “connector,” “connection,” or the like (including plurals) when referring to the hardware device of the present application encompasses physical connectors (e.g. ¼ in, 3.5 mm, RCA, USB, and other types of physical connectors) as well as wireless connectors, (e.g. Bluetooth, Wi-Fi, and other types of wireless connections).

### Golden Signal

One aspect of the present application provides a golden analog electrical audio signal, or a “golden signal,” that is specifically engineered to enable super-resolution evaluation down to signal sample quantization error levels. In one embodiment, the golden signal is created by multiplying two audio signals: a sinusoidal frequency sweep and a custom square wave frequency sweep. In this way, the sinusoidal frequency sweep and the custom square wave frequency sweep are modulated on top of each other.

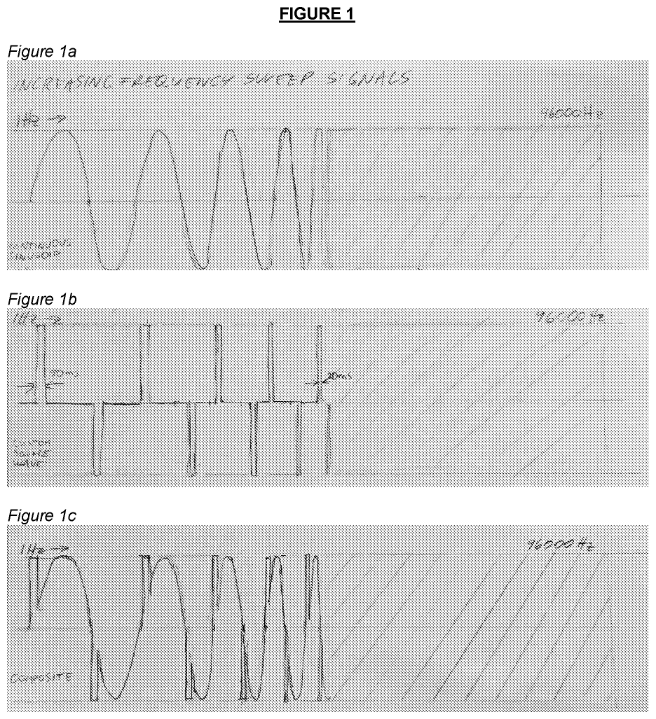

FIG. 1a depicts one embodiment of a sinusoidal frequency sweep. In this embodiment, the sinusoidal frequency sweep is an analog audio signal having a continuously increasing frequency from 1 Hz to 96 KHz. The signal is encoded at a high sampling rate (192,000 samples per second, i.e. 192 kHz) and high sample bit depth (32 bits). However, the present application also encompasses other similar sinusoidal frequency sweeps having different endpoints, different sampling rates, and different bit depths. For example, the upper endpoint of the frequency sweep (96 kHz in the example above) can be any frequency that is approximately half the value of the sampling rate (192 KHz in the example above) or less, and the lower endpoint of the frequency sweep (1 Hz in the example above) can be any frequency that is lower than the upper endpoint. It is critical to select a frequency range that will enable full evaluation of the quality of the hardware or system being tested when considering the intended uses of the hardware or system. For example, if an amplifier for a headphone is being tested, typically the frequency range selected should be sufficient to evaluate at least the human audible range, i.e. the range of frequencies audible to a human (about 20 Hz to about 20 kHz).

FIG. 1b depicts one embodiment of a custom square wave frequency sweep. In this embodiment, the custom square wave frequency sweep is an analog audio signal having a continuously increasing frequency from 1 Hz to 96 KHz. The custom square wave in this embodiment is a modified square wave that, unlike a normal square wave, contains narrow square peaks similar to a pulse wave. In the embodiment shown in FIG. 1b, the width of each square peak is about 5% of the period of the square wave. For example, the first period of the wave shown in FIG. 1b is 1 Hz, and the width of the square peak is 50 ms. As shown in FIG. 1b, as the period decreases, the width of the square peak also decreases so that the width remains about or exactly 5% the width of the square wave. It is intended the present application encompass other peak widths for the modified square wave, including (but not limited to) about 1%, 2%, 3%, 4%, 6%, 7%, 8%, 9%, 10%, 11%, 12%, 13%, 14%, 15%, 16%, 17%, 18,%, 19%, 20%, 21%, 22%, 23%, 24%, and 25%. It may also be provided the peak widths fall within a certain range, including about 1%-5%, 1%-10%, 1%-15%, 1%-20%, 1%-25%, 5%-10%, 5%-15%, 5%-20%, 5%-25%, 10%-15%, 10%-20%, 10%-25%, 15%-20%, 15%-25%, and 20-25% of the period of the square wave. The modified square wave sweep signal is encoded at a high sampling rate (192,000 samples per second, i.e. 192 KHz) and high sample bit depth (32 bits). As with the sinusoidal frequency sweep, however, the present application also encompasses other frequency sweeps having different endpoints, different sampling rates, and different bit depths.

FIG. 1c depicts one embodiment of a golden analog electrical audio signal or golden signal. The golden analog electrical audio signal is a composite of the sinusoidal frequency sweep shown in FIG. 1a and the custom square wave frequency sweep shown in FIG. 1b. As shown in FIG. 1c, the combination of the custom square wave sweep and sinusoidal frequency sweep creates a wave having sharp profiles and increasingly narrow gaps between the peaks of the square portions and the sinusoidal portions of the composite waveform. This composite wave permits high-resolution audio signal analysis, as a lower quality signal (e.g. a signal produced from lower quality hardware) will be unable to maintain the resolution required to reproduce these features, even at high sampling rates and bit depths.

It is important to select endpoints, sampling rates, and bit depths for the custom square wave frequency sweep and the sinusoidal frequency sweep to permit the two signals to be multiplied to produce the golden analog electrical audio signal, or golden signal.

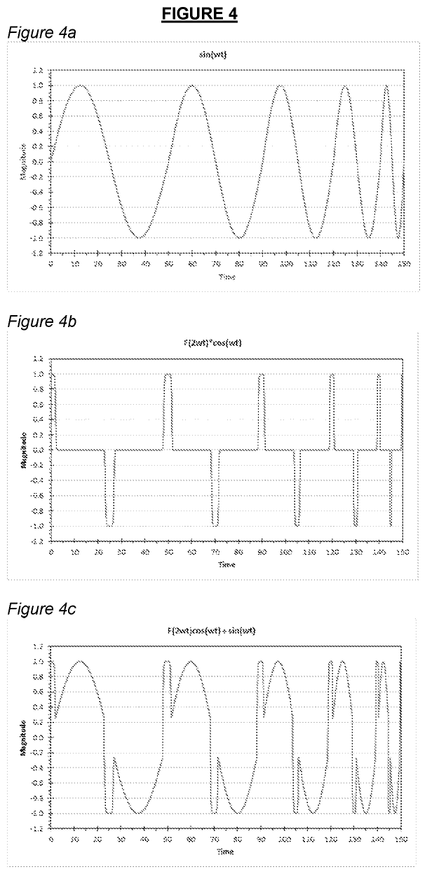

FIG. 4 depicts other embodiments of a sinusoidal frequency sweep, a custom square wave frequency sweep, and a golden analog electrical audio signal.

FIG. 4a, in particular, depicts an embodiment of a sinusoidal frequency sweep. This embodiment was generated using the function shown in Eq. 1.

$${F ( {ω}_{i} {t}_{j} )}_{0} = sin ( {ω}_{i} {t}_{j} ) \qquad ( Eq . 1 )$$

where ωᵢ=2πfᵢ and (in arbitrary units) frequency fᵢ=0.02, 0.025, 0.0333, 0.05 and 0.01. To generate a swept-frequency sinusoidal waveform, there are a total of five time periods depicted in FIG. 4a. Each time period corresponds to a single frequency fᵢ=1/tⱼ. After one full period at each frequency, the time period is reset to run from 0 to tⱼ₊₁=1/fᵢ₊₁ at the next frequency fᵢ+1. The sinusoidal function shown in FIG. 4a may continue to be indexed to higher frequencies as desired to cover the entire frequency range of interest.

FIG. 4b plots the square-wave function, given by the first term in the expression in Eq. 2 below, multiplied by cos(ωt) which is a modulating function. Note that the frequency of the square-wave generator is 2ω whereas the cosine function is frequency ω. The square-wave generator thus puts-out positive-going, unit-magnitude, square-wave pulses. Since the frequency is double that of the cosine function, each positive square-wave pulse lines up precisely with each extrema of the cosine function. As a result of the multiplication, every other pulse of the square wave becomes a negative-going, unit magnitude pulse.

$${F ( {ω}_{i} {t}_{j} )}_{1} = \frac{A}{b + {e}^{[ d + c * cos ( 2 {ω}_{i} {t}_{j} ) ]}} \times cos ( {ω}_{i} {t}_{j} ) \qquad ( Eq . 2 )$$

Specific Eq. 2 parameter values used to generate the plot in FIG. 4b are: 2ω=4πf wherein 2f=0.04, 0.05, 0.0667, 0.1, 0.2; and A=1, b=1, c=65, d=58. The time period in Eq. 2 was indexed in the same manner as described above for Eq. 1 to generate the swept-frequency square waveform of FIG. 4b.

FIG. 4c is generated by simply adding the frequency-indexed sinewave function Eq. 1 to the modulated square-wave indexed pulse-train of Eq. 2 to generate the final golden signal represented by Eq. 3.

$$F ( {ω}_{i} {t}_{j} ) = {F ( {ω}_{i} {t}_{j} )}_{0} + {F ( {ω}_{i} {t}_{j} )}_{1} = sin ( {ω}_{i} {t}_{j} ) + \frac{A cos ( {ω}_{i} {t}_{j} )}{b + {e}^{[ d + c * cos ( 2 {ω}_{i} {t}_{j} ) ]}} \qquad ( Eq . 3 )$$

It will be appreciated that other values of the parameters shown above are possible. For example, it should be recognized that the frequency (f) may be varied such that a frequency sweep across an entire desired range may be produced, e.g., from 1 Hz to 96 KHz as shown in the example depicted in FIG. 1a. It is also possible to vary f as a function of t so that f changes continuously.

FIG. 4c depicts one embodiment of a golden analog electrical audio signal, or golden signal. The golden analog electrical audio signal is a composite of the sinusoidal frequency sweep shown in FIG. 4a and the custom square wave frequency sweep shown in FIG. 4b. As shown in FIG. 4c, the combination of the custom square wave sweep and sinusoidal frequency sweep creates a wave having sharp profiles and increasingly narrow gaps between the peaks of the square portions and the sinusoidal portions of the composite waveform. This composite wave permits high-resolution audio signal analysis, as a lower quality signal (e.g. a signal produced from lower quality hardware) will be unable to maintain the resolution required to reproduce these features, even at high sampling rates and bit depths.

It is important to select function values for the custom square wave frequency sweep and the sinusoidal frequency sweep to permit the two signals to be multiplied to produce the golden analog electrical audio signal, or golden signal.

### Hardware Devices

In one aspect, the present application provides for hardware devices that can be used to evaluate electrical analog signals or to evaluate certain audio hardware, such as amplifiers, ADCs, and DACs.

In one embodiment, the hardware device includes a plurality of components. In some embodiments, the hardware device includes a memory to store the golden signal and/or a test signal. Thus, the golden signal need not be generated each time the hardware device is used, although it is possible to generate the golden signal anew each time the hardware device is used.

In some embodiments, the hardware device includes a line-in for receiving a test signal. The test signal is a signal that is generated using hardware that is intended to be used with a transducing device, e.g. an amplifier, ADC, DAC, etc. The test signal should be as similar to the golden signal as is possible to reproduce using the hardware that is being tested. Thus, for example, if the hardware being tested is an amplifier, the test signal may be produced by using the amplifier to amplify the golden signal. The amplified signal can then be evaluated using the devices, systems, and methods described in this application.

If the hardware being tested is an analog to digital converter (ADC), for example, the golden signal can be converted to a digital signal and then converted back to an analog signal using a preselected digital to analog converter (DAC) of sufficient quality as to not degrade the quality of the signal. The resulting analog signal could then be evaluated using the devices, systems, and methods described in this application. It would be possible to preselect such a DAC of sufficient quality using the devices, systems, and methods described in this application.

If the hardware being tested is a digital to analog converter (DAC), for example, the golden signal can be digitized using a preselected analog to digital converter (ADC) of sufficient quality as to not degrade the quality of the signal and then converted back to an analog signal using the DAC. The resulting analog signal could then be evaluated using the devices, systems, and methods described in this application. It would be possible to preselect such an ADC of sufficient quality using the devices, systems, and methods described in this application.

In some embodiments, the hardware device can include a preselected DAC and/or ADC. In some embodiments, the hardware device can include a version of the golden signal that has already been digitized.

In some embodiments, the hardware device includes one or more line-out connections for sending the analog golden signal and/or a digital version thereof. In this way, the hardware device can send the digital signal to the hardware being evaluated. It is also within the scope of the present application, however, to provide the golden signal wholly separate from the hardware device. However, the hardware device must have access to the golden signal and the test signal to evaluate the quality of the test signal. Therefore, if the golden signal is not kept on the hardware device, the hardware device should have a way to obtain the golden signal, e.g. by a connector.

Some embodiments of the hardware device include an SoC (system on a chip). In some embodiments, the SoC includes hardware encoded logic for evaluating the golden signal and test signal. In some embodiments, the SoC includes one or more of a CPU, GPU, coprocessor, microcontroller, wired/wireless communication interface, memory, I/O, secondary storage, power supply, and/or other components. In some embodiments, the SoC may be included in a package on package (POP) configuration. In some embodiments, the hardware device includes a motherboard-based architecture, which separates components based on function and connects them through a central interfacing board (rather than a single integrated circuit). The motherboard-based architecture can include all of the components that would be included in an SoC. In some embodiments, the hardware device can include an SoC and motherboard-based architecture.

In some embodiments, the hardware device includes a high-quality digital signal processor (DSP). In some embodiments, the hardware device includes an oscilloscope. In some embodiments, the hardware device includes a digital audio workstation.

In some embodiments, the hardware device includes a plurality of buttons, switches, and/or toggles for controlling the hardware device. In some embodiments, the hardware device includes a keyboard. In some embodiments, the hardware device includes a connector to permit connection to another device configured to control the hardware device. In some embodiments, the hardware device includes a display or readout. In some embodiments, the hardware device includes a connector to permit the transfer of data or information containing results and/or a graphical depiction thereof. In some embodiments, the hardware device includes a power supply or a power connector to power the hardware device.

In a particular embodiment, the hardware circuit is built using SoC, DSP, DACs of extremely high fidelity, and classic electrical components of high quality: resistors, coils, transistors, diodes, transformers, input/output connectors, LEDs, and switches. The hardware device includes a physical switch or GUI letting the operator initiate golden signal and test signal playback and analysis. The results are saved onboard memory in the SoC as a log file and/or shown on a graphical user interface (GUI).

### Evaluation and Testing

In one aspect, the present application provides ways to evaluate the quality of electrical analog signals and certain audio hardware, such as amplifiers, ADCs, and DACs.

In one embodiment, the hardware device receives a test signal and performs a time-sync operation to temporally align the test signal with the golden signal. The hardware device then divides the test signal and golden signal into a plurality of bins, each bin representing a different sub-band and temporal domain combination. The signal is divided into sub-bands using a filter bank for each temporal resolution used. In one embodiment, three temporal domains are used, which are preferably 0-100 microseconds (ultra-fast analysis), 100 microseconds-10 milliseconds (fast analysis), and 10 milliseconds-200 milliseconds. In one embodiment, the plurality of sub-bands are each 1 Hz in width and cover the entire frequency range of the test signal, i.e., the sub-bands are 1-2 Hz, 2-3 Hz, 3-4 Hz, . . . 95,999-96,000 Hz for a test signal having a frequency range of 1 Hz to 96,000 Hz (96 KHz).

In other embodiment, other temporal domains may be used. For example, two, three, four, five, or more temporal domains may be used. In some embodiments, the ultra-fast analysis domain(s) are on the order of microseconds (or lower), tens of microseconds, and/or thousands of microseconds, the fast analysis domain(s) are on the order of tens of microseconds, hundreds of microseconds, milliseconds, tens of milliseconds, or hundreds of milliseconds, and the remaining domain(s) are on the order of milliseconds, tens of milliseconds, hundreds of milliseconds, thousands of milliseconds, or higher.

In another embodiment, other sub-bands may be used. For example, the plurality of sub-bands may be of varying width, e.g. 1 Hz, 2 Hz, 3 Hz, 4 Hz, 5 Hz, etc. The plurality of sub-bands may cover other total frequency ranges, e.g., 1 Hz to 96 KHz, 20 Hz to 20 kHz, 1 Hz to 20 KHz, 20 KHz to 96 KHz, or sub-portions thereof. Selecting different time and frequency domains can impact the resolution of the analysis.

The present application also encompasses various combinations of the temporal domains and sub-bands described above.

In one embodiment, once the hardware device has divided the test signal and golden signal into different bins, the hardware device evaluates the objective quality of the test signal by aggregating the differences between the test signal and the golden signal across all bins. The hardware device can then determine an objective quality of the test signal using this aggregate amount.

In one embodiment, the following approach may be used to determine the aggregate difference between the test signal and the golden signal.

n = TOTAL_NUMBER_OF_SAMPLES;
b = TOTAL_NUMBER_OF_SUBBAND_BINS;
X = GOLDEN_SIGNAL(n);
Y = TEST_SIGNAL(n);
fX = FILTERBANK_SUBBAND_OUTPUT(X);
fY = FILTERBANK_SUBBAND_OUTPUT(Y);
C =
CATEGORY_CLASS_DESIGNATION_PROBABILITY_ESTIMATE;
FOR (i = 1 to b)
C = C + SUM(DIFF(fX(i), fY(i));
END
IF ( C ≤ 0.01); CATEGORY_CLASS = A; END
IF ( ( C ≤ 0.1 ) && (C > 0.01) ); CATEGORY_CLASS = B; END
IF ( ( C ≤ 0.4 ) && (C > 0.1) ); CATEGORY_CLASS = C; END
IF ( ( C ≤ 0.7 ) && (C > 0.4) ); CATEGORY_CLASS = D; END
IF ( ( C ≤ 1.0 ) && (C > 0.7) ); CATEGORY_CLASS = E; END
IF ( C > 1.0 ); CATEGORY_CLASS = F; END

Thus, in some embodiments, the system, method, or device of the present application determines a number of parameters from input high fidelity analog electrical signal and combines them into a single score representing the overall audio signal quality, or CATEGORY/CLASS:
“A CATEGORY/CLASS” is the perfect ideal playback quality at maximum resolution 192000 sampling rate and 32-bit signal;
“B CATEGORY/CLASS” is the transducer playback quality level at maximum resolution 192000 sampling rate and 32-bit signal;
“C CATEGORY/CLASS” is the dynamic transducer playback CLASS at maximum resolution 192000 sampling rate and 32-bit signal;
“D CATEGORY/CLASS” is the speech/handset quality CLASS at maximum resolution 192000 sampling rate and 32-bit signal;
“F CATEGORY/CLASS” is a very poor-quality signal at maximum resolution 192000 sampling rate and 32-bit signal.

It is within the scope of this application to provide other methods of aggregating the difference between the golden signal and the test signal across the various time domains and frequency domains selected. It is also within the scope of this application to preferentially select only certain values to aggregate across the time domains and frequency domains depending on the preferences of the operator. It is also within the scope of this application to preferentially weight certain values greater than others when aggregating across the time domains and frequency domains depending on the preferences of the operator. In such embodiments, weighting and/or filtering functions would be applied to the summation operation shown above. These approaches may be used in combination with one another to tailor the response depending on the preferences of the operator. For example, if the operator believed a response in a certain frequency range, e.g. portions of the audible range associated with bass, midrange, treble, etc. were especially important, it is within the scope of this application to allow the operator to preferentially select or weight those ranges (as well as to adjust the values of the weights).

Thus, in one aspect, it is possible to objectively evaluate analog electrical audio signals with super-resolution, down to 1 μs in the time domain and 1 Hz in the frequency domain. It is also within the scope of this application to evaluate electrical signals with other resolutions in the time domain, including 2 μs, 3 μs, 4 μs, 5 μs, 10 μs, 15 μs, 20 μs, 25 μs, 30 μs, 40 μs, 50 μs, 75 μs, and 100 μs. It is also within the scope of this application to evaluate electrical signals with other resolutions in the frequency domain, including 2 Hz, 3 Hz, 4 Hz, 5 Hz, 10 Hz, 15 Hz, 20 Hz, 25 Hz, 30 Hz, 40 Hz, 50 Hz, 75 Hz, and 100 Hz. In some embodiments, the electrical signals are evaluated with a resolution from 1-5 μs, 1-10 μs, 1-25 μs 1-50 μs, 1-75 μs, 1-100 μs, 5-10 μs, 5-25 μs, 5-50 μs, 5-75 μs, 5-100 μs, 10-25 μs, 10-50 μs, 10-75 μs, 10-100 μs, 25-50 μs, 25-75 μs, 25-100 μs, 50-75 μs, 50-100 μs, and 75-100 μs in the time domain. In some embodiments, the electrical signals are evaluated with a resolution from 1-5 Hz, 1-10 Hz, 1-25 Hz 1-50 Hz, 1-75 Hz 1-100 Hz, 5-10 Hz, 5-25 Hz 5-50 Hz, 5-75 Hz, 5-100 Hz, 10-25 Hz 10-50 Hz, 10-75 Hz, 10-100 Hz, 25-50 Hz, 25-75 Hz, 25-100 Hz, 50-75 Hz, 50-100 Hz, and 75-100 Hz in the frequency domain. It is within the scope of this application to provide combinations of the foregoing resolutions, depending on the parameters chosen for the golden signal and the hardware chosen for the hardware device.

As indicated above, certain embodiments of the hardware device of the present application can provide a numerical value of the aggregated differences, or can associate the numerical value with another indicator, e.g. a letter grade. For example, in one embodiment, if the sum of the differences between the test signal and the golden signal are less than 0.01%, the signal is graded as an “A”, if the differences are between 0.01% and 0.10%, the signal is graded as a “B”, if the differences are between 0.10% and 0.40%, the signal is graded as a “C”, if the differences are between 0.40% and 0.70%, the signal is graded as a “D”, if the differences are between 0.70% and 1%, the signal is graded as “E”, and if the differences are greater than 1%, the signal is graded as an “F”. It should be understood other threshold values may be used for each letter grade, or other kinds of indicators may be used, including (but not limited to) number grades, descriptive labels (“excellent”, “great”, “good”, etc.), ranking, all of which fall within the intended scope of the present application.

In some embodiments, the signal quality grade or indicator can be output to a log file. In some embodiments, the signal quality grade or indicator can be displayed using a display or a graphical user interface (GUI).

Another aspect of the present application provides a method of testing the hardware device itself. One embodiment provides configuring the hardware device in a feedback loop, where the golden signal is provided from an output on the hardware device to the input on the hardware device designed to receive a test signal. In this way, the golden signal is evaluated against itself using the components in the hardware device. Such testing may be carried out to ensure the hardware device contains components capable of evaluating a test signal with the resolution required by the operator. Such testing may also be carried out to ensure the hardware is functioning correctly before evaluating a test signal.

We claim:

1. A method of evaluating the quality of an analog audio signal, the method comprising:
providing a golden analog audio signal,
providing a test analog audio signal,
comparing the differences between the golden analog audio signal and the test analog audio signal,
obtaining an objective indication of the quality of the test analog audio signal.

2. The method of claim 1,
wherein the golden analog audio signal is a combination of a sinusoidal frequency sweep and a custom square wave frequency sweep.

3. The method of claim 2,
wherein the sinusoidal frequency sweep continuously increases in frequency from a lower endpoint to an upper endpoint.

4. The method of claim 3,
wherein the lower endpoint is 1 Hz and the upper endpoint is 92 KHz.

5. The method of claim 2,
wherein the custom square wave frequency sweep continuously increases in frequency from a lower endpoint to an upper endpoint, wherein the custom square wave has continuously changing square peaks, each peak having a peak width that is 1-25% of the instantaneous period of the custom square wave.

6. The method of claim 5,
wherein each peak has a peak width that is 5% of the instantaneous period of the square wave.

7. The method of claim 5,
wherein the lower endpoint is 1 Hz and the upper endpoint is 92 KHz.

8. The method of claim 1,
wherein the test signal is prepared using the golden signal.

9. The method of claim 8,
wherein the test signal is prepared by having a device to be tested using the golden signal to produce the test signal.

10. The method of claim 1,
wherein comparing the differences between the golden analog audio signal and the test analog audio signal comprises the following steps:
dividing the golden analog audio signal and test analog audio signal in the time domain and in the frequency domain into a plurality of pairs, each pair comprising a golden analog audio signal portion and a test analog audio signal portion,
ascertaining the difference between each signal in the pair.

11. The method of claim 10,
wherein obtaining an objective indication of the quality of the test analog audio signal comprises the following steps:
obtaining an aggregate difference by aggregating the difference between each signal in each pair,
providing an indication corresponding to the aggregate difference.

12. A device for evaluating the quality of an analog audio signal, comprising
a memory having a golden analog audio signal,
wherein the device is configured to perform the method of any of claims 1 to 11.

13. An analog audio signal comprising
a combination of a sinusoidal frequency sweep and a custom square wave frequency sweep, wherein the sinusoidal frequency sweep continuously increases in frequency from a lower endpoint to an upper endpoint, wherein the custom square wave frequency sweep continuously increases in frequency from the lower endpoint to the upper endpoint.

14. The method of claim 13,
wherein the upper endpoint is about half of the sampling rate of the analog audio signal, wherein the lower endpoint is below the upper endpoint.

15. The method of claim 14,
wherein the lower endpoint is 1 Hz and the upper endpoint is 96 KHz.

16. The method of claim 13,
wherein the analog audio signal is encoded at a sampling rate of 192 KHz and a bit depth of 32 bits.

17. The method of claim 13,
wherein the custom square wave has continuously changing square peaks, each peak having a peak width that is 1-25% of the instantaneous period of the custom square wave.

18. The method of claim 17,
wherein each peak has a peak width that is 5% of the instantaneous period of the square wave.
